(19) United States
(12) Patent Application Publication
(10) Pub. No.: US 2023/0214570 A1
(43) Pub. Date: Jul. 6, 2023

(54) CAD Based Design of Heterogenous heat spreader

(71) Applicant: Phononics Ltd, Nesher (IL)

(72) Inventors: Shye Shapira, Kiryat Tivon (IL); Inbar Dag, Nesher (IL)

(73) Assignee: Phononics Ltd, Nesher (IL)

(21) Appl. No.: 18/149,662

(22) Filed: Jan. 3, 2023

Related U.S. Application Data
(60) Provisional application No. 63/266,362, filed on Jan. 3, 2022.

(51) Int. Cl. G06F 30/392

(52) U.S. Cl. CPC G06F 30/392; H01L 23/3732

(57) ABSTRACT

A method for designing hotspots heat dissipation elements (HHDEs), the method includes (i) obtaining integrated circuit (IC) design information about the integrated circuit; (ii) finding, based on the IC design information, hotspots; (iii) and designing, by a computerized system, the HHDEs, based on the IC design information. At least one HHDE of the HHDEs is made of diamond.

### CROSS REFERENCE

This application claims priority from U.S. provisional patent 63/266,362 filing date 3 Jan. 2022 which is incorporated herein in its entirety.

### BACKGROUND

FIG. 1 illustrates a modern integrated circuit (IC) chip (denoted silicon chip 10) has modes of operation where certain areas, “hot operation areas” 12, generate a high heat flux (high heat power flow per unit area) where others do not. The dimensions of these hot operation areas may be from 1 mm² to 50 mm², where the chip may be 10 mm² to 2500 mm². The chip thickness in a package may be from 50 to 800 microns. In multicore processors the processor cores are “hot operation areas”.

For clarity we describe in some detail the “hot operation area” problem in ICs implemented in silicon chips where the performance limited is the speed of the IC. “Hot operation areas” or “hotspots” limiting the performance and the reliability of electronic systems are common to all semiconductor chip-based systems, also ones that contain discrete devices such as power management and microwave power devices, implemented in silicon or other semiconductors such as GaN or SiC. The performance limited in such systems may be the maximum output power of the device or some other figure of merit. The dimensions of the hotspots may be smaller. This invention pertains to all such systems.

The proper operation and reliability of the IC is limited by the operating temperature in the chip. In silicon-based ICs it should normally not exceed 100 degrees centigrade. Thus, the speed of the IC operation (“clock speed”) is limited by the maximum operating temperature at the hotspots and its variation between them. Chip cooling methods, such as heat pipes, heat sinks, and active cooling systems have an upper limit for the heat flux they can remove from chip, while keeping the junction temperature below the maximum allowed operating temperature.

Thus, when a cooling system is used to cool a chip that has hotspots, its performance is limited by these hotspots. In the lower heat flux regions, the full capacity of the cooling system is not utilized. In such conditions the chip operation speed does not obtain its maximum possible level as enabled by the cooling method.

To address this issue, heat spreading material with high heat conductivity are placed along the entire surface of an IC chip—between the surface and the cooling system (FIG. 2B). This spreads the heat generated in the IC chip to a wider cross section on the cooling system interface, thus reducing the heat flux to a value manageable by the cooling system. A lower heat flux though the whole thermal stack incurs a smaller junction to case temperature drop and reduces the temperature differences between the hotspots at the chip surface. FIG. 3 displays impact of high thermal conductivity heat spreader (in this case microcrystalline diamond) on hotspot temperature. The integration of the high thermal conductivity heat spreader reduces the hotspot temperature in all 8 cores by an average of 19° C. and reduces the variance of hotspot temperature by a factor of 3.

Materials with high heat conductivity may be expensive and may be hard to manufacture in the required dimensions compatible with the 300 mm wafer size that is used in advanced semiconductor process. Examples of high heat conductivity materials include, SiC, graphite, graphene, and diamond which has the best-known heat conductivity (for example, single crystalline diamond, multi-crystalline diamond or nano-diamond). Thus, the cost and manufacturability challenges can be addressed by constructing an heterogeneous heat spreader which is made of one material with segments of a second high thermal conductivity material embedded in it. Such a configuration is depicted in FIG. 2C. Optimized placement and design of segments of high thermal conductivity material in a heterogeneous heat spreader material, as depicted in FIG. 2C, will result in reduced junction temperatures not significantly different than those achieved with a full planar sheet of high thermal conductivity as demonstrated in FIG. 2B, but a significantly reduced bill of materials. FIG. 4 displays a broader class of embedding segments of high thermal conductivity material in the chip and cooling system. As the figure suggests, the embedding may be for example, in the active device wafer or in a separate heat spreader or could be in an heterogeneous heat spreader wafer, that is later bonded to the silicon wafer containing the active circuit. Such a configuration is described in FIG. 7.

The production scheme of a packaged integrated circuit with a heterogeneous heat spreader requires coordination between the integrated circuit design, the heterogenous heat spreader design and integration so that the placement coordinates, dimensions and shape of the high thermal conductivity regions is commensurate with the hotspots dimensions coordinates and heat power generation. This flow is depicted in FIG. 5C.

Since in this invention, the higher cost material with higher thermal conductivity will be placed only in specified areas according to the device known location of hot generation spots the area of the more expensive high thermal conductivity material, may be much smaller than the semiconductor chip area. Hence the cost of the heterogenous heat spreader will be reduced compared to a planar one with similar thermal performance.

The heat spreading efficiency is enhanced when the heat spreader die is located as close as possible to the heat generation spot at the front side of the device, with minimal thickness of the semiconductor substrate between the device front side and the heat spreader die. Thus, the current invention may involve thinning of the semiconductor substrate to the required thickness, and this may be done selectively as recessed areas only at the areas of interest.

A major challenge in the design and construction of a heterogeneous heat spreader is the placement of the high thermal conductivity segments directly under the hotspots. This placement is mostly circuit specific and requires a mechanism, the heat spreader GDS, for the transfer of information from the circuit design and simulation tools to the heat spreader design and manufacturing tools. Also, the determination of the required heat spreader dimensions and location may need to be derived from a post- circuit design thermal simulation. In a holistic system the circuit design and simulation include both the electronic and thermal simulation so that the heat spreader and circuit are simultaneously designed.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings:

FIG. 1 is an example of hot areas on an active silicon chip;

FIGS. 2A, 2B and 2C are examples of cross sectional view of a silicon chip in package;

FIG. 3 is an example of an impact for high thermal conductivity heat spreader such as a microcrystalline diamond heat spreader on hotspot temperature;

FIG. 4 illustrates various examples of heterogeneous heat spreaders with embedded high thermal conductivity material;

FIG. 5A illustrates an example of an integrated circuit design flow;

FIG. 5B illustrates an example of an integrated circuit production flow;

FIG. 5C illustrates an example of a thermally aware integration and manufacturing flow of the heterogeneous heat spreader prepared to be bonded to an active wafer;

FIG. 5D illustrates an example of an integration and manufacturing flow of the heterogeneous heat spreader;

FIG. 5E illustrates an example of an integration and manufacturing flow of the heterogeneous heat spreader;

FIG. 5F illustrates an example of an integration and manufacturing flow of the heterogeneous heat spreader;

FIGS. 6A-6C illustrate an example of a representation of recesses fabricated within substrate wafer according to pattern generated by CAD system;

FIGS. 7A-7C illustrate an example of a mode of use of the heterogeneous heat spreader embedded in substrate wafer;

FIG. 8 illustrates an example of a placement on whole wafer or on wafer level heterogeneous heat spreader with repeated multi-die pattern;

FIGS. 9A-9D illustrate an example of embedding of diamond heat spreaders in the back side of a semiconductor wafer;

FIGS. 10A-10C illustrate an example of embedding of diamond heat spreaders in the back side of a semiconductor wafer;

FIGS. 11A and 11B illustrate an example of a cross section of the active die after dicing with embedded diamond heat spreader;

FIGS. 12A-12C illustrate examples of hotspots, heat dissipated from each hotspots and the diamond heat spreaders to be positioned in thermal communication with the hotspots;

FIGS. 13A-13C illustrate examples diamond heat spreaders to be positioned in thermal communication with the hotspots, of a placement of an integrated circuit on a landing wafer and of a wafer level bonding tool that bonds the integrated circuits;

FIG. 14 illustrates an example of a method; and

FIG. 15 illustrates an example of a method.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that can be executed by the system and should be applied mutatis mutandis to a non-transitory computer readable medium that stores instructions that once executed by a computer result in the execution of the method.

The terms “hotspot” and “hot area” are applied in an interchangeable manner.

There may be provided a method for designing hotspots heat dissipation elements (HHDEs), the method may include (i) obtaining integrated circuit (IC) design information about the integrated circuit, wherein the IC includes one or more active components such as but not limited to transistors; (ii) finding, based on the IC design information, hotspots; and (iii) designing, by a computerized system, the HHDEs, based on the IC design information. At least one HHDE of the HHDEs is made of diamond. An aggregate area of the HHDEs is a fraction of an area of a bottom of the IC. The computerized system may include one or more processing circuits and/or one or more memory resources and/or one or more communication units.

There may be provided a non-transitory computer readable medium for designing hotspots heat dissipation elements (HHDEs), the non-transitory computer readable medium stores instructions that once executed by a processor, cause the processor to: (i) obtain integrated circuit (IC) design information about the integrated circuit, wherein the IC includes one or more active components such as but not limited to transistors; (ii) find, based on the IC design information, hotspots; and (iii) design the HHDEs, based on the IC design information. At least one HHDE of the HHDEs is made of diamond. An aggregate area of the HHDEs is a fraction of an area of a bottom of the IC. The computerized system may include one or more processing circuits and/or one or more memory resources and/or one or more communication units

There may be provided a method for designing an integrated circuit (IC), the method includes (i) obtaining hotspots heat dissipation elements (HHDEs) design information about HHDEs; and (ii) designing the IC to comprise HHDEs that are in thermal communication with hotspots of the IC, wherein the designing is based at least in part on the HHDEs design information, wherein the IC includes one or more active components. At least one HHDE of the HHDEs is made of diamond. An aggregate area of the HHDEs is a fraction of an area of a bottom of the IC.

There may be provided a non-transitory computer readable medium for designing an IC, the non-transitory computer readable medium stores instructions that once executed by a processor, cause the processor to: (i) obtain hotspots heat dissipation elements (HHDEs) design information about HHDEs; and (ii) design the IC to comprise HHDEs that are in thermal communication with hotspots of the IC, wherein the designing is based at least in part on the HHDEs design information, wherein the IC includes one or more active components. At least one HHDE of the HHDEs is made of diamond. An aggregate area of the HHDEs is a fraction of an area of a bottom of the IC.

There is provided an electronic chip with an integrated heterogeneous heat spreader that is manufactured with the use of Graphic Display System files or other data files to transfer location and shape data of the high thermal conductivity segments in the chip or heat spreader.

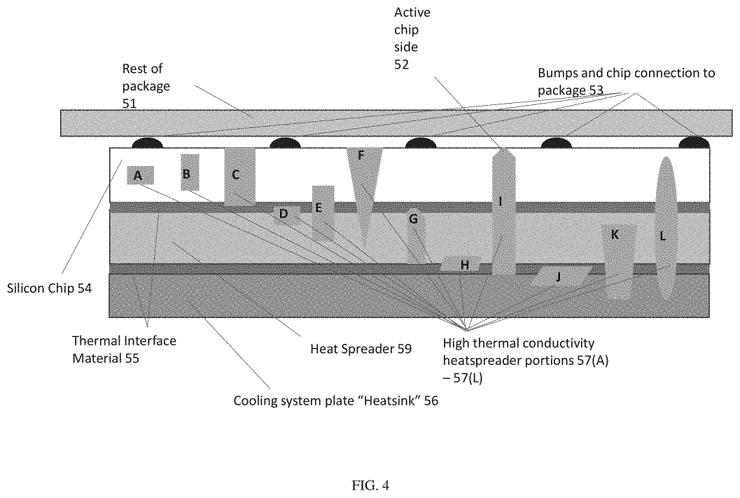

Using CAD and Graphic Display System files or other data files allows, in a circuit specific manner, to implement the selective placement of high thermal conductivity material in proximity to the hot operation areas of an electronic circuit, match it to any electrical design and optimize thickness, shape, and vertical position of the high thermal conductivity segments. FIG. 4 schematically shows the general process of integration of CAD module in the heterogeneous heat spreader technology.

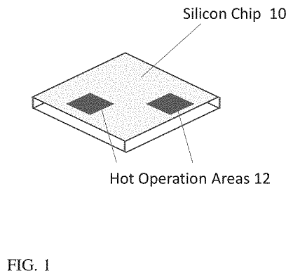

FIG. 1 illustrates an example of hot areas on an active silicon chip.

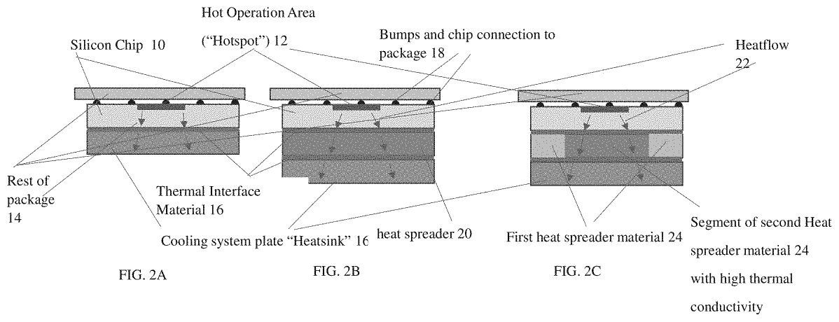

FIGS. 2A-2C illustrates an example of a cross section view of a silicon chip in package. The chip is electronically connected to the package through bumps face down in “flip chip” geometry. Excess heat is removed from the back of the chip to the cooling system. In FIG. 2A the silicon chip is connected directly to the heatsink which also functions as a heat spreader. In FIG. 2B a heat spreader is used. The heatsink is connected to cooling fins or a water-cooling system (not shown) directly or through mechanism such as a heat pipe or vapor chamber (not shown). The thermal interface material may be an organic (thermal grease) or metallic layer (such as Indium) or dielectric (in the case of direct wafer bonding) with thicknesses ranging from 0.01 to 100 microns. It is used in electronic packaging systems to ensure good thermal contact between materials or can be used at wafer bonding level to physical bond between wafers. FIG. 2C demonstrates the concept of a heterogeneous heat spreader where a high thermal conductivity material is material is embedded in the heat spreader only in regions under the hotspots where the thermal flux is high, thus achieving at lower bill of material while maintaining a similar reduced junction temperature for the hotspot. While less common a heat spreader can also be placed on the front of the chip close to the devices,

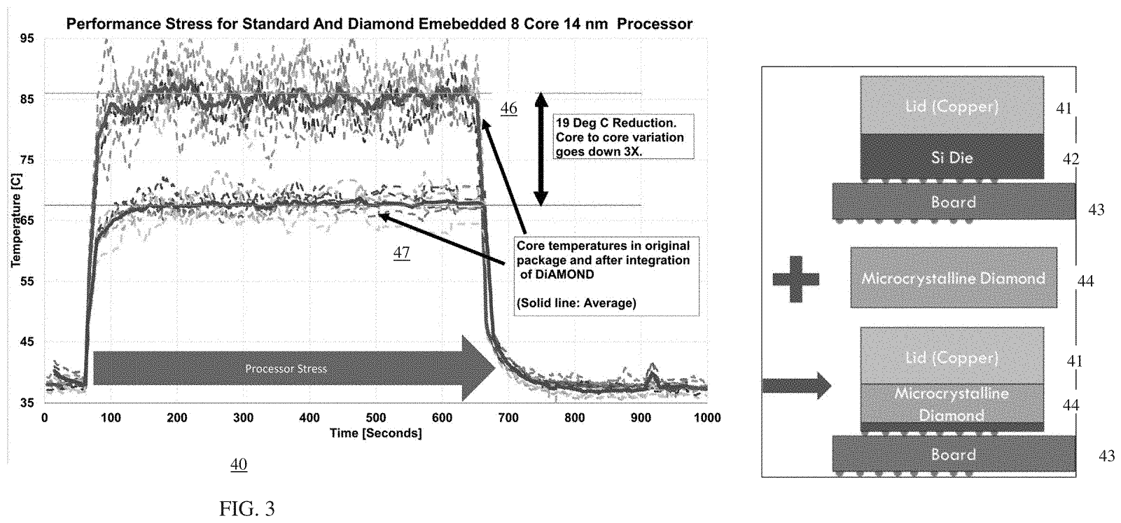

FIG. 3 illustrates an example (graph 40—especially curves 46 and 47) of an impact for high thermal conductivity heat spreader (in this case microcrystalline diamond—denoted 44) on hotspot temperature—when placed between board 43 and lid (copper) 41. A silicon die 42 may be initially positioned between board 43 and lid 41. The integration of the high thermal conductivity heat spreader reduces the hotspot temperature in all eight cores by an average of 19 degrees and reduces the variance of hotspot temperature by a factor of three. (Presented as Performance Enhancement of Integrated Circuits and Power Devices via Embedded Diamond Heat Management proceeding of 2021 IEEE International Conference on Microwaves, Antennas, Communications and Electronic Systems (COMCAS) IEEExplore library.)

FIG. 4 illustrates an example of implementations of the heterogeneous heat spreader with embedded high thermal conductivity material 57(A)-57(L). The figure also illustrates rest of package 52, achuve chip side 52, bumps and chip connections to package 53, silicon chip 54, heat spreader 59, thermal interface material 55 (appears above the heat spreader 59 and below the heat spreader), and cooling plate “heatsink” 56.

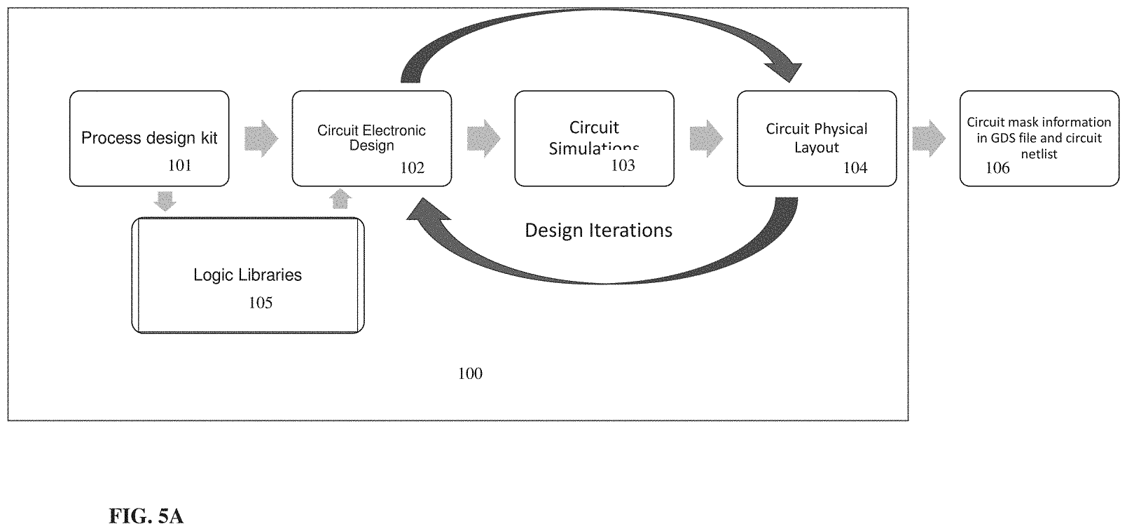

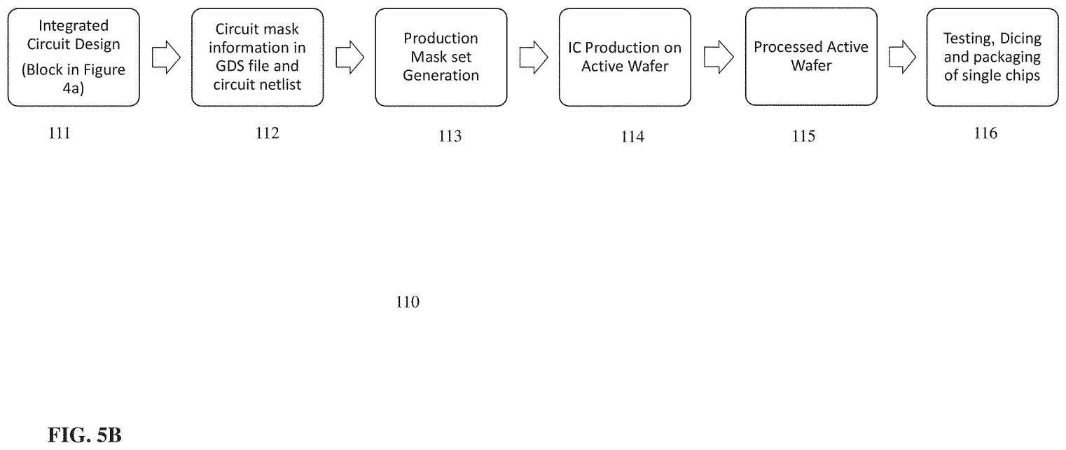

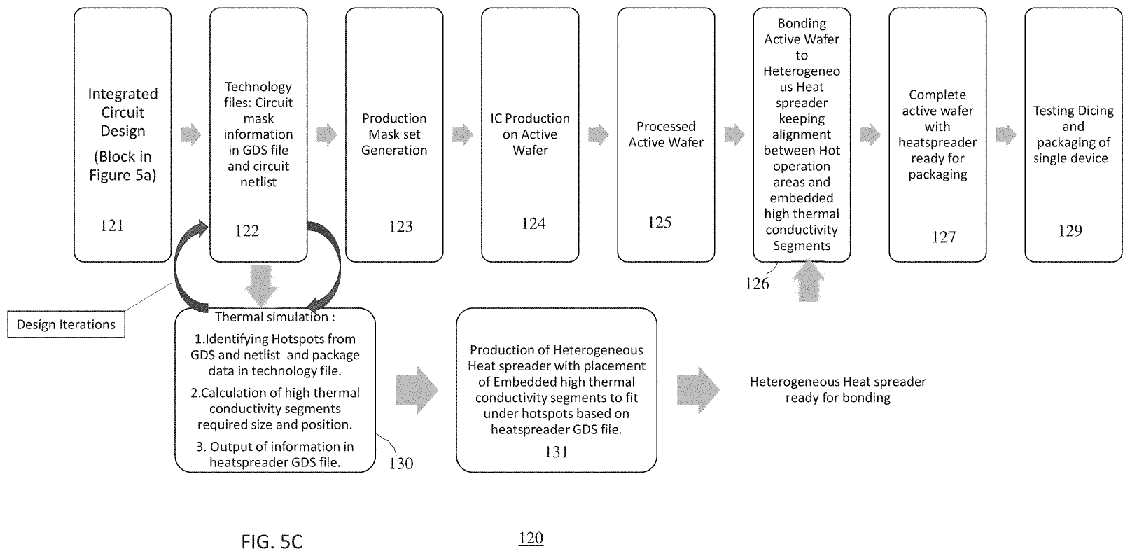

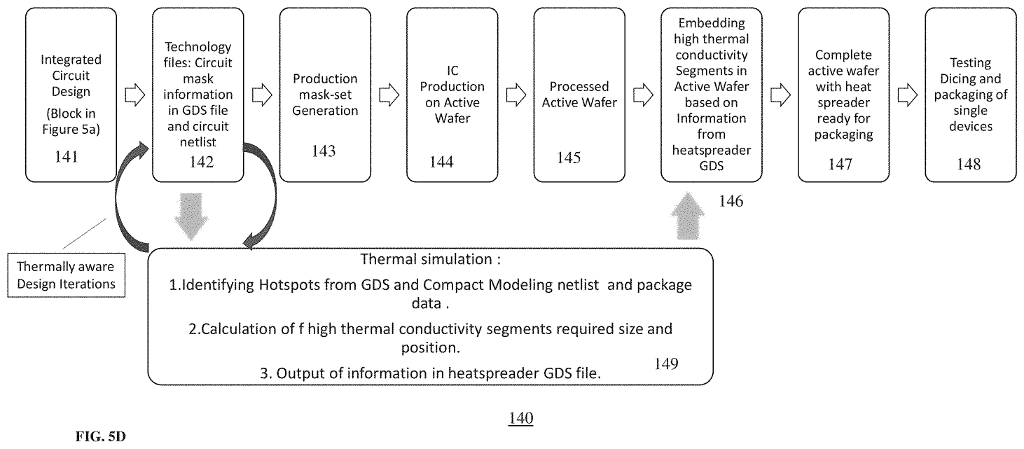

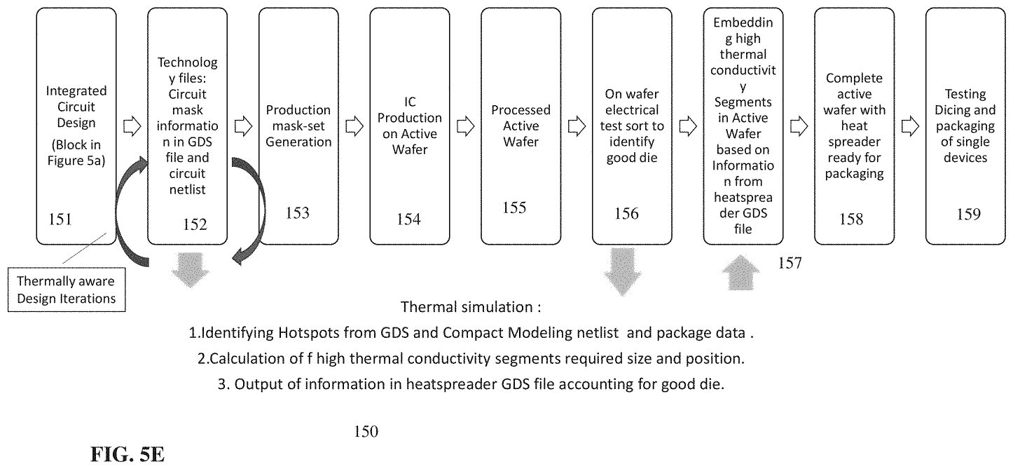

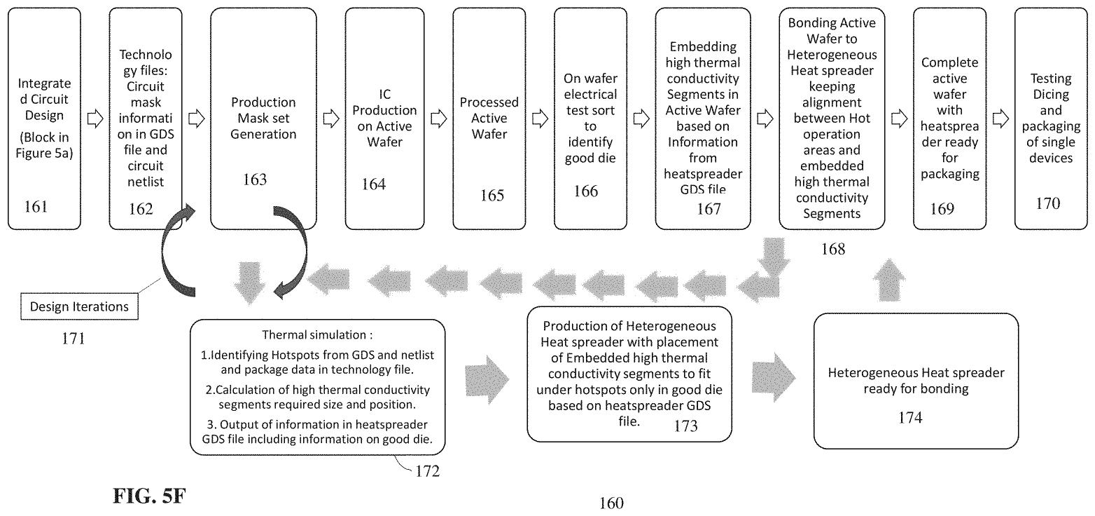

FIG. 5A describes a common existing integrated circuit design flow, which ends with the creation of a first GDS file which has information on the device shapes dimensions and location and circuit netlist which allows simulation of the electrical performance of the devices. FIG. 5B also describes the further steps of converting the technology files to an actual mask set which is used in fabrication process of the device wafers, the device production at wafer level, chip dicing and packaging.

FIG. 5A illustrates an example of an integrated circuit design flow 100 that includes steps 101-106 that output circuit mask information in GDS file and circuit netlist 106.

FIG. 5B illustrates an example of integrated circuit production flow 110 that include steps 111-116.

FIG. 5C illustrates an example of a thermally aware integration and manufacturing flow 120 of the heterogeneous heat spreader prepared to be bonded to an active wafer. The flow 120 includes steps 121-131. The placement of the embedded diamond segments described here is done custom per design, based on GDS and netlist files which allow to determine the locations of hot operation areas.

FIG. 5D illustrates an example of integration and manufacturing flow 140 of the heterogeneous heat spreader where the high thermal conductivity dice are embedded directly to an active wafer. The flow 140 includes steps 141-149. The placement of the embedded high thermal conductivity segments described here is done custom per design, based on GDS and netlist files which allow to determine the locations of hot operation areas.

FIG. 5E illustrates an example of a possible integration and manufacturing flow 150 of the heterogeneous heat spreader where the high thermal conductivity dice are embedded directly to an active wafer. The process is identical to the one described in FIG. 4D but includes on wafer sort that allows information on good die to be incorporated in the GDS files, so that the high thermal conductivity material is placed only under good die. The flow 140 includes steps 151-159.

FIG. 5F illustrates an example of integration and manufacturing flow 160 of the heterogeneous heat spreader to an active wafer. The placement of the embedded high thermal conductivity segments described here is done custom per design, based on GDS and netlist files which allow to determine the locations of hot operation areas. Electrical sort information is used to embed high thermal conductivity segments only under good die. The flow 160 includes steps 161-174.

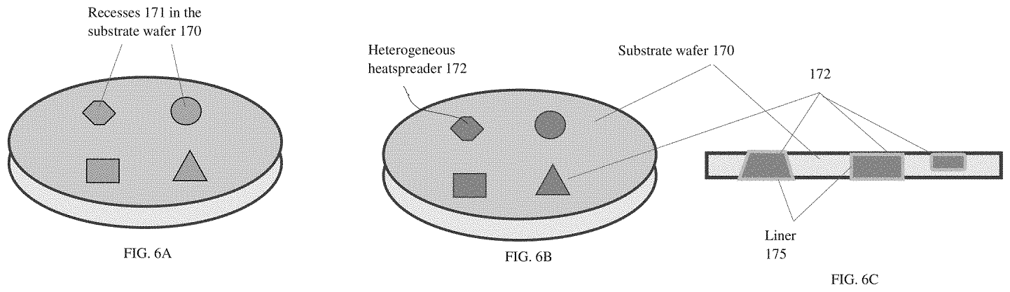

In one embodiment heterogeneous heat spreader can be integrated in substrate wafer as shown in FIGS. 6A-6C. Using CAD simulation exact hot spot coordinates are provided via GDS or other information file. These coordinates are used to fabricate and transfer special recess pattern to substrate wafer, as shown in FIG. 6A. These recesses can have equal shape as well as coordinate-dependent specially adapted shape to improve heat transfer. These recesses can be fabricated in the substrate wafer by any technique, such as RIE, wet etch, laser ablation, thermochemical etching, micro-CNC drilling, mechanical grinding, etc. The depth of recesses can vary from several nm to hundreds of microns, while lateral dimensions can vary from tens of microns to several millimeters. The roughness of recess wells and bottom can be in sub-nanometer to hundreds of micron range.

Each recess is filled by specially prepared heat spreader, as shown in FIG. 6B. By filling we mean any proximity connection between two materials, such as temporary bonding, permanent bonding, adhesive bonding, mechanical pressing etc. The bonding between the heat spreader and the substrate wafer may be done by any method that can ensure good enough adhesion. It can be done by direct or indirect bonding. It may involve intermediate layers for bonding, adhering, welding, soldering, sintering, fusion or any other mechanism of attaching to surfaces to each other. It may involve the application of pressure, heat, gas flow, radiation, or any other additional process parameter that may be required for bonding. It may involve additional post-bonding processes such as annealing or curing that may enhance the bond quality, strength, thermal conductivity, and other properties.

The heat spreader production process may involve any required step of surface preparation prior to the positioning of the heat spreaders at the recesses. For example, it may involve cleaning, polishing, activation, heating, drying, coating by primer, adhesion layer, metallization, and any additional process required for bonding or for improving the thermal conductivity across the bonding interface. This is applicable to both parts to be bonded, the substrate wafer and the heat spreaders.

In one implementation, to allow the adhesion and relief of stress due to differences between thermal expansion coefficients, a liner (FIG. 6C) is included between the embedded heat spreader segments within the embedding substrate wafer. The liner can be composed from any of the following materials but not only limited to, SiO₂ or Graphite, Indium silver or polymeric glue.

The positioning of the heat spreaders into the recessed areas at the semiconductor wafer may be done by any method that is capable of die to wafer positioning. It can be done manually or automatically, it can be done for example by pick and place tool, by die attach tool, or any other capable means. It can be done by positioning the diamond heat spreaders one by one at the recesses, or by pre-distribution of the diamond heat spreaders on a carrier, and collective transfer of multiple number of heat spreaders from the carrier to the semiconductor wafer recesses. The final result is demonstrated by FIG. 6B and cross section is shown in FIG. 6C where all the recesses filled by heat spreaders.

The positioning of the heat spreaders into the recessed areas at the semiconductor wafer may be done to all the prepared recesses or may be done selectively only to part of them based on sort wafer map that identify only good dies. This method reduces the cost of spending good expensive heat spreaders on scrapped dies. An example of such flow is described in FIG. 5(e).

The topographic level of the heat spreaders after embedding them to the semiconductor wafer may be planarized with the substrate wafer level, or alternatively it may be higher or lower than the substrate level. If required, additional planarization processes such as lapping, polishing, selective etching may be added in order to planarize the heat spreaders and the substrate to identical level.

FIG. 6A illustrates an example of recesses 171 fabricated within substrate wafer 170 according to pattern generated by CAD system. FIG. 6B illustrates an example of heterogeneous heat spreader 172 embedded in each recess in substrate wafer 170. This wafer may be referred to as embedding substrate wafer. FIG. 6C illustrates an example of a cross section view. It consists of embedded heterogenous heat spreader segments in substrate wafer 170. Heterogenous heat spreader segments may be embedded in such a way that at least one side is not exposed at the wafer edge as the portion on the right demonstrated. Liner 175 ensures adhesion, good thermal contact between embedded heat spreader segments and the embedding subtract wafer.

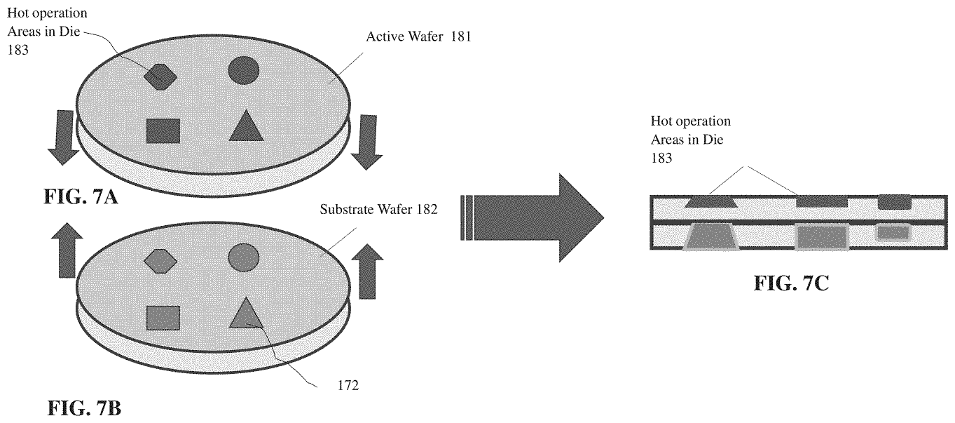

FIGS. 7A-7C illustrates an example of mode of use of the heterogeneous heat spreaders 172 embedded in substrate wafer. FIG. 7A illustrates an example of an active semiconductor wafer 181 with schematic hot spots 183 on the top before integration. FIG. 7B illustrates an example of a heterogenous heat spreader formed by embedding segments of high thermal conductivity material in substrate wafer or other material. FIG. 7C illustrates an example of a cross section view of active wafer bonded to the heterogeneous heat spreader. The active wafer and the Heterogeneous heat spreader are aligned such that the embedded segments of high thermal conductivity material are directly beneath the hotspots. Heat spreader GDS files containing the information on size and location of the segments of high thermal conductivity material are used for the production of the heterogeneous heat spreader.

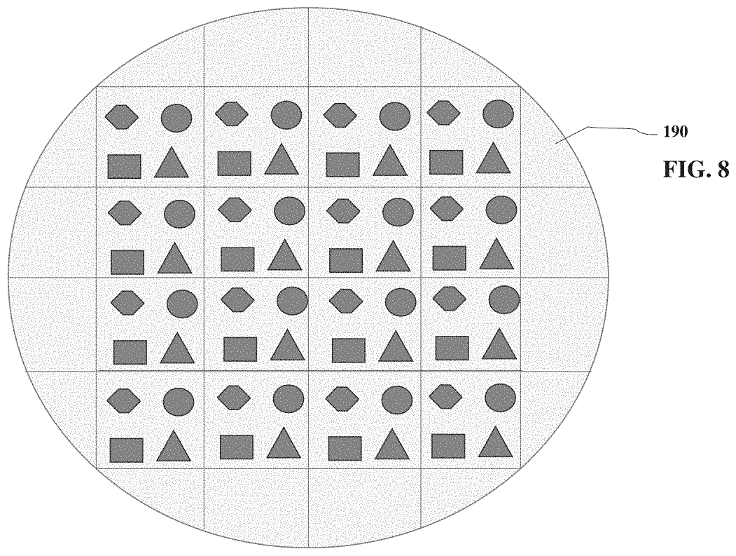

FIG. 8 illustrates an example of a placement on whole wafer 109 or on wafer level heterogeneous heat spreaders with repeated multi-die pattern. This scenario holds for integration of heterogeneous heat spreader segments within substrate wafer as well as with active device wafer.

In one form of use of the heterogeneous heat spreader, it is bonded to an active semiconductor wafer that optionally has been thinned. (FIG. 8). The bonding process may be done by any method that can ensure good enough adhesion. It can be done by direct or indirect bonding. It may involve intermediate layers for bonding, adhering, welding, soldering, sintering, fusion or any other mechanism of attaching to surfaces to each other. It may involve the application of pressure, heat, gas flow, radiation, or any other additional process parameter that may be required for bonding. It may involve additional post-bonding processes such as annealing or curing that may enhance the bond quality, strength, thermal conductivity and other properties.

The preparation of both substrates (Semiconductor active wafer and heterogeneous heat spreader substrate) to the bonding may involve any required step of surface preparation prior to the positioning of the heat spreaders at the recesses. For example, it may involve cleaning, polishing, activation, heating, drying, coating by primer, adhesion layer, metallization, and any additional process required for bonding or for improving the thermal conductivity across the bonding interface. This is applicable to both parts to be bonded, the substrate wafer and the heat spreaders.

The heat spreader segments placement in the wafer is planned such that they are under the “hot operation regions”, can be based on the circuit layout files (Graphic GDS files) that have been processed to identify the “hot operation areas”. The heterogeneous heat spreader in the above implementation need to be aligned to the active wafer hot operation regions such that the embedded heat spreader segments are placed beneath them and in the closest proximity when they are bonded together.

It should be emphasized that the whole process described on FIGS. 6A-6C and 7A-7C (e.g., recess creation, heat spreader embedment, bonding etc.) can be done on the level of the photolithographic field within the reticle using appropriate GDS output of CAD thermal simulation. FIG. 8 shows schematic view of the substrate wafer with heterogeneous heat spreader with repeated multi-die pattern.

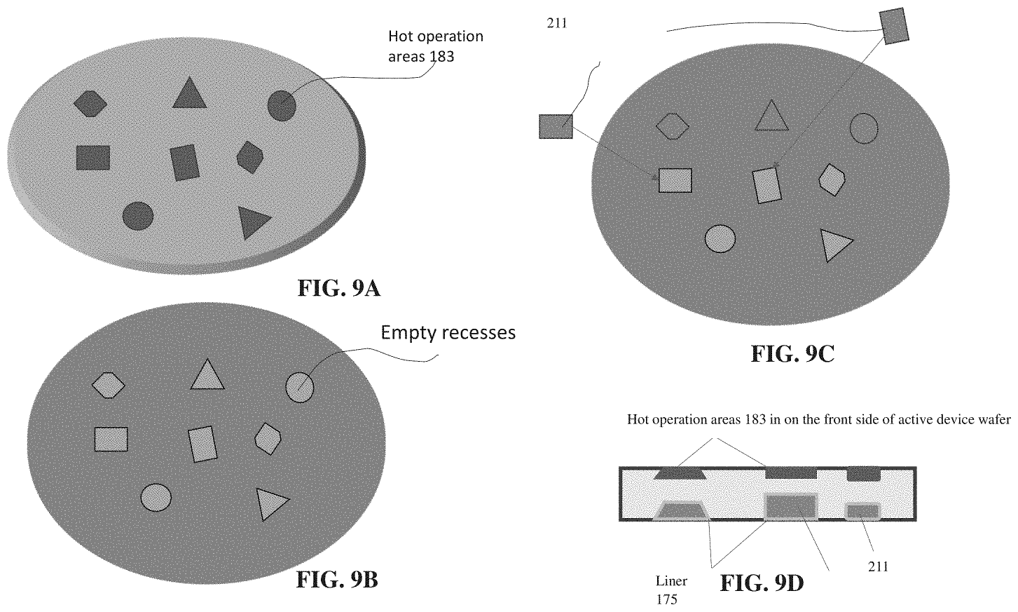

In one embodiment heterogeneous heat spreader can be integrated in the active semiconductor wafer as shown in FIGS. 9A-9D. Using CAD simulation exact hot spot coordinates are provided (FIG. 9A). These coordinates stored in a second GDS file are used to fabricate and transfer special recess pattern to the backside of the active semiconductor wafer, as shown in FIG. 9B. These recesses can have equal shape as well as coordinate-dependent specially adapted shape to improve heat transfer. These recesses can be fabricated in the substrate wafer by any technique, such as RIE, wet etch, laser ablation, thermochemical etching, micro-CNC drilling, milling, mechanical grinding, etc. The depth of recesses can vary from several nm to hundreds of microns, while lateral dimensions can vary from tens of microns to several millimeters. The roughness of recess wells and bottom can be in sub-nanometer to hundreds of micron range. The semiconductor wafer may be thinned prior to the creation of the recesses, or after the creation of the recesses. In some cases, it may left at the original thickness without thinning.

Each recess is filled by specially prepared heat spreader, as shown in FIG. 9C. By filling we mean any proximity connection between two materials, such as temporary bonding, permanent bonding, adhesive bonding, mechanical pressing etc. The bonding between the heat spreader and the active semiconductor wafer may be done by any method that can ensure good enough adhesion. It can be done by direct or indirect bonding. It may involve intermediate layers for bonding, adhering, welding, soldering, sintering, fusion or any other mechanism of attaching to surfaces to each other. It may involve the application of pressure, heat, gas flow, radiation, or any other additional process parameter that may be required for bonding. It may involve additional post-bonding processes such as annealing or curing that may enhance the bond quality, strength, thermal conductivity and other properties.

The heat spreader production process may involve any required step of surface preparation prior to the positioning of the heat spreaders at the recesses. For example, it may involve cleaning, polishing, activation, heating, drying, coating by primer, adhesion layer, metallization, and any additional process required for bonding or for improving the thermal conductivity across the bonding interface. This is applicable to both parts to be bonded, the substrate wafer and the heat spreaders.

In one implementation, to allow the adhesion and relief of stress due to differences between thermal expansion coefficients, a liner (FIG. 9D) is included between the embedded heat spreader segments within the embedding substrate wafer. The liner can be composed from any of the following materials but not only limited to, SiO₂ or Graphite, Indium silver or polymeric glue.

The positioning of the heat spreader into the recessed areas at the active semiconductor wafer may be done by any method that is capable of die to wafer positioning. It can be done manually or automatically, it can be done for example by pick and place tool, by die attach tool, or any other capable means. It can be done by positioning the diamond heat spreaders one by one at the recesses, or by pre-distribution of the diamond heat spreaders on a carrier, and collective transfer of multiple number of heat spreaders from the carrier to the semiconductor wafer recesses. The final result is demonstrated by FIG. 9C and cross section is shown in FIG. 9D where the recesses are being filled by heat spreaders.

The positioning of the heat spreaders into the recessed areas at the semiconductor wafer may be done to all the prepared recesses or may be done selectively only to part of them based on sort wafer map that identify only good dies. This method reduces the cost of spending good expensive heat spreaders on scrapped dies.

The topographic level of the heat spreaders after embedding them to the semiconductor wafer may be planarized with the substrate wafer level, or alternatively it may be higher or lower than the substrate level. If required, additional planarization processes such as lapping, polishing, selective etching may be added in order to planarize the heat spreaders and the substrate to identical level.

The heat spreader segments placement in the wafer is planned such that they are under the “hot operation regions”, can be based on the circuit layout files (Graphic GDS files) that have been processed to identify the “hot operation areas”. The heterogeneous heat spreader in the above implementation needs to be aligned to the active wafer hot operation regions such that the embedded heat spreader segments are placed beneath them and in the closest proximity when they are bonded together.

It should be emphasized that the whole process described on FIGS. 9A-9D (e.g., recess creation, heat spreader embedment, bonding etc.) can be done on the level of the photolithographic field within the reticle using appropriate GDS output of CAD thermal simulation. FIG. 8 shows schematic view of the active semiconductor wafer with heterogeneous heat spreader with repeated multi-die pattern.

FIGS. 9A-9D illustrate an example of an embedding of diamond heat spreaders 211 in the back side of a semiconductor wafer—at locations that are directly below hot spots 183. FIG. 9A illustrates an example of a front side of active semiconductor wafer with schematic hot spots on the top before integration. FIG. 9B illustrates an example of a back side of active semiconductor wafer with recesses created beneath hot spot before integration. FIG. 9C illustrates an example of an integrated backside of active semiconductor wafer demonstrates the positioning of the heat spreader segments of different size and shapes into the recessed areas at the active device wafer backside. Information from the CAD thermal simulation is used to manufacture the IC to determine the locations of the embedded diamond portions. FIG. 9D illustrates an example of a cross section view of integrated active device wafer with embedded heat spreader segments. Liner ensures adhesion, good thermal contact between embedded heat spreader segments and the embedding subtract wafer.

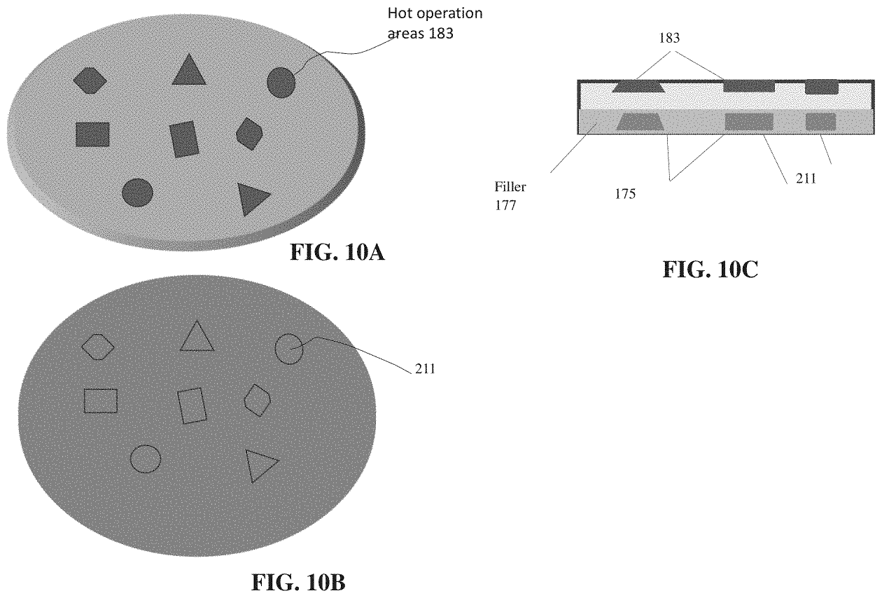

FIGS. 10A-10C illustrate embedding of diamond heat spreaders 211 in the back side of a semiconductor wafer—at locations that are directly below hot spots 183. FIG. 10A illustrates an example of a front side of active semiconductor wafer with schematic hot spots on the top before integration. FIG. 10B illustrates an example of a back side of active semiconductor wafer thinned on the wafer level to required (optimized) thickness to allow closest proximity of the heat spreader to hot spot area. Heat spreaders are bonded to the back side of the thinned device wafer. Information from the CAD thermal simulation is used to manufacture the IC to determine the locations of the embedded heat spreader segments. FIG. 10C illustrates an example of a cross section view of integrated active device wafer with embedded heat spreader segments. Liner 175 ensures adhesion, good thermal contact between embedded heat spreader segments and the embedding subtract wafer. Filler 177 is used to bring wafer backside to uniform thickness.

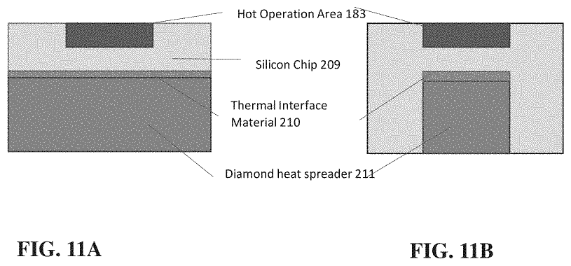

FIGS. 11A and 11B illustrate examples of cross sections of the active die after dicing with embedded diamond heat spreader. In FIG. 11A the diamond heat spreader 211 is at the die size. In FIG. 11B the diamond heat spreader 211 is smaller than the die and is selectively positioned at a recess, at the vicinity of the hot operation area 183. A thermal heat interface material 210 is positioned above the diamond heat spreader 211.

In one embodiment heterogeneous heat spreader segments can be integrated in active semiconductor wafer without recess creation. Using CAD simulation exact hot spot coordinates are provided (FIG. 10A) The flow of the process is described in FIG. 5D. These coordinates are used to fabricate and transfer special heat spreader segments to backside of active semiconductor wafer. In some cases, the active device wafer can be thinned (grinded, etched, polished) to the minimal thickness (calculated by CAD) and the heat spreader segments can be bonded to its backside. (FIG. 10B). The bonding between the heat spreader and the active semiconductor wafer may be done by any method that can ensure good enough adhesion. It can be done by direct or indirect bonding. It may involve intermediate layers for bonding, adhering, welding, soldering, sintering, fusion, or any other mechanism of attaching to surfaces to each other. It may involve the application of pressure, heat, gas flow, radiation, or any other additional process parameter that may be required for bonding. It may involve additional post-bonding processes such as annealing or curing that may enhance the bond quality, strength, thermal conductivity, and other properties.

Following the heat spreaders segments bonding, the active device wafer backside can be selectively coated or filled with any material to meet electrical and planarization requirements of further dicing and packaging procedures. FIG. 10C shows cross sectional view of integrated active device wafer with embedded heat spreader segments without recess creation.

In one embodiment separate dies from the active wafer after singulation are bonded to the heterogeneous heat spreader. In yet another implementation singulated dies from the heterogeneous heat spreader are bonded to the active wafer. FIGS. 11A and 11B shows schematic cross section of the single active device die with integrated heat spreader segments. FIG. 11A shows the heat spreader at the size equal to die size. FIG. 11B shows the case where heat spreader is smaller than the die and is selectively positioned at a recess, at the vicinity of the hot operation area.

All scenarios can be implemented at the end of the semiconductor wafer process, or before the end, after grinding or after SORT evaluation. In the latest case SORT wafer map can be used to integrate heat spreader segments using SORT wafer map, thus significantly reducing the time consumption and cost of the process.

After completing the heat spreader embedding at the back side, the semiconductor wafers may continue to the following required processes. If front side protection layer or temporary carrier was applied, it involves the removal of the layer prior to the next process steps.

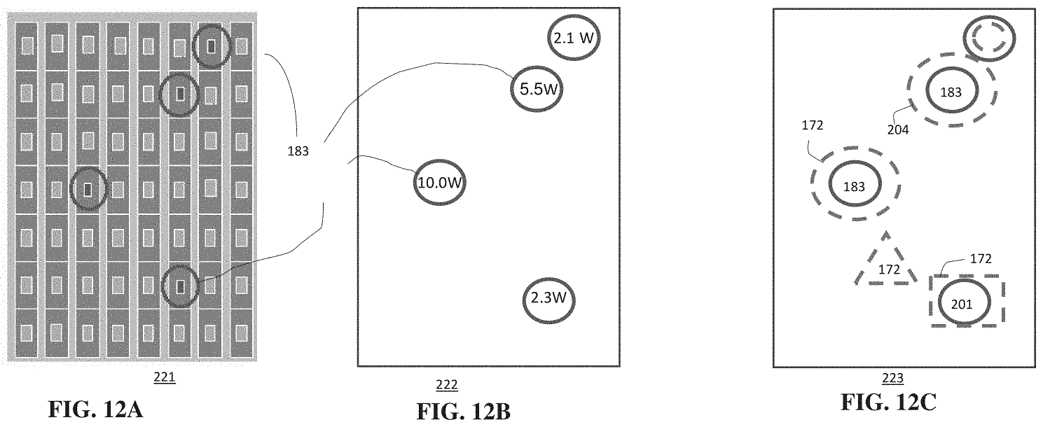

FIGS. 12A-12C illustrate examples of hotspots 183, heat dissipated from each hotspots and the heterogeneous heat spreaders 172 to be positioned in thermal communication with the hotspots.

FIG. 12A illustrates (image 221) hotspots identified in locations in circuit layout based on the circuit simulation.

FIG. 12B Illustrates (image 222) the GDS file generated with hotspot coordinate, size, and amount of generated power info.

FIG. 12C includes (image 223) dashed lines denote a second GDS based computer generated plan for HHDE placement on wafer or heterogeneous heat spreader.. The file contains the shape, dimensions and coordinates of HHDE that were computed by a thermal aware program to optimize HHDE minimum size and maximum hotspot temperature reduction. If possible the GDS file may be merged with the file of FIG. 12B

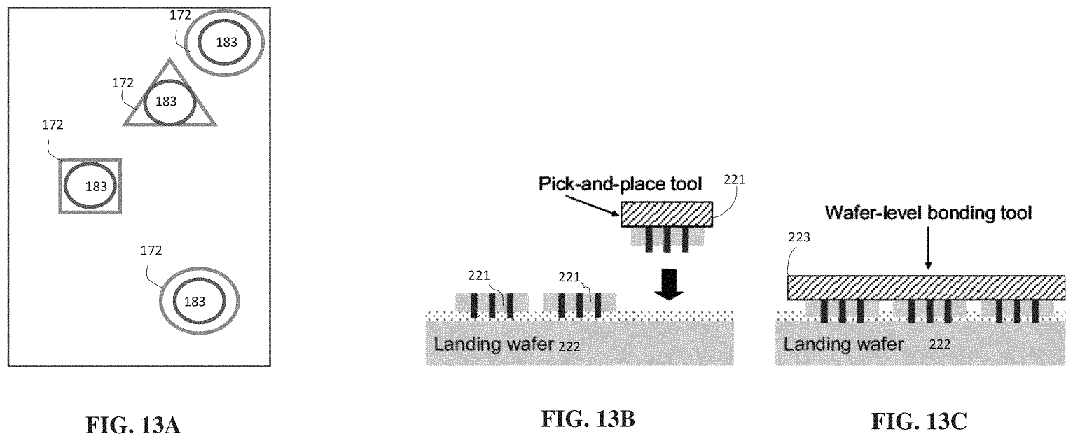

FIGS. 13A-13C illustrate examples of the use of GDS files to use in a pick and place method for HHDE integration. FIG. 13A displays the contents of a GDS file that include locations of hotspots 183 and locations of heterogeneous heat spreaders 172—as described in FIG. 12B and 12C. The coordinates of the hotspots the shape size and coordinates of the HHDE are described. FIG. 13B depicts a pick and place tool placing the HHDE on the back of the semiconductor wafer containing the integrated circuits (“landing wafer”). FIG. 13C depicts a bonding process of all HHDE

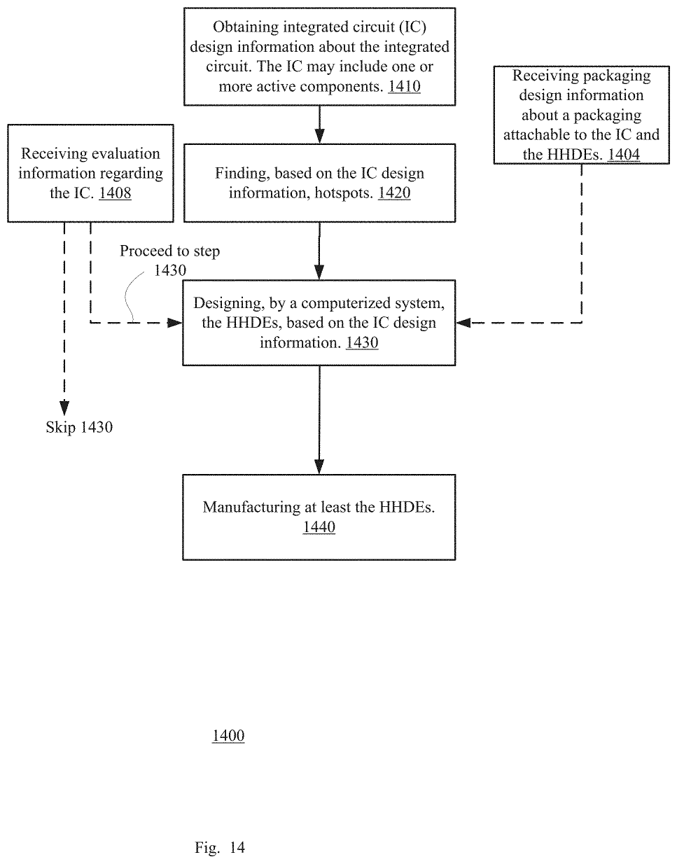

FIG. 14 illustrates an example of method 1400 for designing hotspots heat dissipation elements (HHDEs).

Method 1400 may start by step 1410 of obtaining integrated circuit (IC) design information about the integrated circuit. The IC may include one or more active components. Examples of active components may include components that have a device function, such as a transistor, resistor, or light emitting diode. The IC may not include any active component.

Step 1410 may be followed by step 1420 of finding, based on the IC design information, hotspots. Step 1420 may include determining the location and/or shape and/or size of the hotspots. Step 1420 may include determining the heat that should be dissipated from each hot spot. Hot spots that require different heat dissipation power are illustrated in FIG. 12B.

Step 1420 may be followed by step 1430 of designing, by a computerized system, the HHDEs, based on the IC design information. Step 1430 may include determining at least one of a location, shape, volume, surface area and material of each HHDE—especially so that each HHDE is capable of dissolving the heat from a hot spot it is allocated to—and is in thermal communication with.

At least one HHDE of the HHDEs is made of diamond.

An aggregate area of the HHDEs may be a fraction of an area of a bottom of the IC. The fraction may be up to 0.1, 0.5, 1, 2, 5, 10, 15, 20, 25, 30, 35, 40 percent of the area of the bottom of the IC. The fraction should provide a tradeoff between cost (as currently HHDEs are much more expensive than other parts of the IC) and heat dissipation.

Alternatively—the HHDEs may cover the entire bottom of the IC or between 41 percent and 99 percent of the area of the bottom of the IC—for example between 41-45, 46-50, 51-55, 56-60, 61-65, 65-70, 71-75, 76-80, 81-85, 86-90, 91-95, 96-99 percent of the area of the bottom of the IC.

It should be noted that the HHDEs may be positioned at the upper surface of upper side of the IC and/or on the front side of the IC.

Method 1400 may include 1404 of receiving packaging design information about a packaging attachable to the IC and the HHDEs.

The determining of step 1430 may be responsive to the packaging design information—as the packaging may impact the heat dissipation from the hotspots.

Method 1400 may include step 1408 of receiving evaluation information regarding the IC, and determining whether to add the HHDEs to the IC based on the evaluation information. For example—method 1400 may include determining not to add the HHDEs to the IC when the evaluation information indicates that the IC is defective.

The IC may include a bulk, a first thermal interface layer, and a heat spreader, wherein the first thermal interface layer is located between a bottom of the bulk and a top of the first thermal interface layer.

Step 1430 may include designing the HHDEs so that at least one of the HHDEs is partially located within the bulk and is partially located within the first thermal interface layer.

Step 1430 may include designing the HHDEs so that a first HHDE is located within the bulk and a second HHDE is located within the first thermal interface layer.

The IC may also include a second thermal interface layer, and a heatsink, wherein the second thermal interface layer is located between a bottom of the heat spreader and a top of the heatsink.

Step 1430 may include designing the HHDEs so that at least one of the HHDEs is partially located within the heatsink and is partially located within the heat spreader.

Step 1430 may include designing the HHDEs so that at least two of the HHDEs differ for each other by shape and size.

Method 1400 may also include step 1440 of manufacturing at least the HHDEs. The manufacturing may also include manufacturing the IC and the HHDE, assembling the packaging and the IC, and the like.

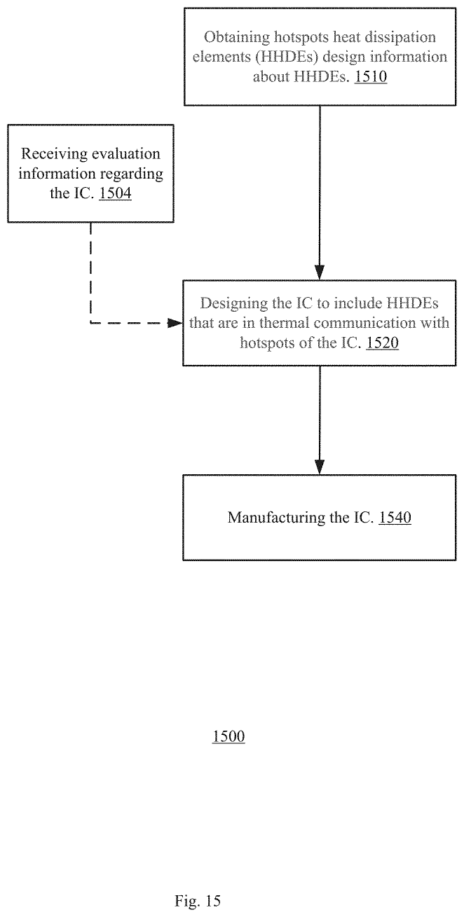

FIG. 15 illustrates an example of a method 1500 for designing an integrated circuit (IC).

Method 1500 may start by step 1510 of obtaining hotspots heat dissipation elements (HHDEs) design information about HHDEs. The information may describe the heat dissipating properties of the HHDEs. For example heat power dissipation per different volumes and/or different shapes and/or different materials and/or different compositions of the HHDEs.

Step 1510 may be followed by step 1520 of designing the IC to include HHDEs that are in thermal communication with hotspots of the IC.

Step 1520 may be based (at least in part) on the HHDEs design information.

The IC may include one or more active components.

At least one HHDE of the HHDEs can be made of diamond.

An aggregate area of the HHDEs is a fraction of an area of a bottom of the IC.

The fraction may be up to 0.1, 0.5, 1, 2, 5, 10, 15, 20, 25, 30, 35, 40 percent of the area of the bottom of the IC. The fraction should provide a tradeoff between cost (as currently HHDEs are much more expensive than other parts of the IC) and heat dissipation.

Alternatively—the HHDEs may cover the entire bottom of the IC or between 41 percent and 99 percent of the area of the bottom of the IC—for example between 41-45, 46-50, 51-55, 56-60, 61-65, 65-70, 71-75, 76-80, 81-85, 86-90, 91-95, 96-99 percent of the area of the bottom of the IC.

Method 1500 may include step 1504 of receiving evaluation information regarding the IC. Step 1504 may be followed by step 1520. Step 1520 may include determining whether to add the HHDEs to the IC based on the evaluation information.

Method 1500 may include step 1540 of manufacturing the IC.

This application provides a significant technical improvement over the prior art—especially an improvement in computer science.

Any reference to the term “comprising” or “having” should be interpreted also as referring to “consisting” of “essentially consisting of”. For example—a method that comprises certain steps can include additional steps, can be limited to the certain steps or may include additional steps that do not materially affect the basic and novel characteristics of the method—respectively.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a computer program product such as non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc. A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system. The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for designing hotspots heat dissipation elements (HHDEs), the method comprises:
obtaining integrated circuit (IC) design information about the integrated circuit;
finding, based on the IC design information, hotspots;
designing, by a computerized system, the HHDEs, based on the IC design information;
wherein at least one HHDE of the HHDEs is made of diamond; wherein an aggregate area of the HHDEs is a fraction of an area of a bottom of the IC.

2. The method according to claim 1, wherein the IC comprises one or more active components.

3. The method according to claim 1, wherein an aggregate area of the HHDEs is a fraction of an area of a bottom of the IC.

4. The method according to claim 1, comprising receiving packaging design information about a packaging attachable to the IC and the HHDEs, and wherein the designing of the HHDEs is further responsive to the packaging design information.

5. The method according to claim 1, comprising receiving evaluation information regarding the IC, and determining whether to add the HHDEs to the IC based on the evaluation information.

6. The method according to claim 5, comprising determining not to add the HHDEs to the IC when the evaluation information indicates that the IC is defective.

7. The method according to claim 1, wherein the IC comprises a bulk, a first thermal interface layer, and a heat spreader, wherein the first thermal interface layer is located between a bottom of the bulk and a top of the first thermal interface layer.

8. The method according to claim 7, wherein at least one of the HHDEs is partially located within the bulk and is partially located within the first thermal interface layer.

9. The method according to claim 7, wherein a first HHDE is located within the bulk and a second HHDE is located within the first thermal interface layer.

10. The method according to claim 7, wherein the IC further comprises a second thermal interface layer, and a heatsink, wherein the second thermal interface layer is located between a bottom of the heat spreader and a top of the heatsink.

11. The method according to claim 10, wherein at least one of the HHDEs is partially located within the heatsink and is partially located within the heat spreader.

12. The method according to claim 1, wherein at least two of the HHDEs differ for each other by shape and size.

13. The method according to claim 1 comprising manufacturing at least the HHDEs.

14. A non-transitory computer readable medium for designing hotspots heat dissipation elements (HHDEs), the non-transitory computer readable medium stores instructions that once executed by a processor, cause the processor to:
obtain IC design information about the integrated circuit;
find, based on the IC design information, hotspots;
design the HHDEs, based on the IC design information; wherein at least one HHDE of the HHDEs is made of diamond.

15. The non-transitory computer readable medium according to claim 14, wherein an aggregate area of the HHDEs is a fraction of an area of a bottom of the IC.

16. The non-transitory computer readable medium according to claim 14, that stores instructions for receiving packaging design information about a packaging attachable to the IC and the HHDEs, and wherein the designing of the HHDEs is further responsive to the packaging design information.

17. The non-transitory computer readable medium according to claim 16, that stores instructions for receiving evaluation information regarding the IC, and determining whether to add the HHDEs to the IC based on the evaluation information.

18. The non-transitory computer readable medium according to claim 16, that stores instructions for determining not to add the HHDEs to the IC when the evaluation information indicates that the IC is defective.

19. A method for designing an integrated circuit (IC), the method comprises:
obtaining hotspots heat dissipation elements (HHDEs) design information about HHDEs; and
designing the IC to comprise HHDEs that are in thermal communication with hotspots of the IC, wherein the designing is based at least in part on the HHDEs design information; wherein at least one HHDE of the HHDEs is made of diamond.

20. The method according to claim 19, wherein an aggregate area of the HHDEs is a fraction of an area of a bottom of the IC.

21. The method according to claim 19, comprising receiving evaluation information regarding the IC, and determining whether to add the HHDEs to the IC based on the evaluation information.

22. The method according to claim 19, comprising manufacturing the IC.
